(19) United States
(12) Patent Application Publication
(10) Pub. No.: US 2023/0381935 A1
(43) Pub. Date: Nov. 30, 2023

(54) REMOVAL TOOL FOR BALL JOINT

(71) Applicant: PI-LIANG WU, Taichung (TW)

(72) Inventor: PI-LIANG WU, Taichung (TW)

(21) Appl. No.: 17/722,397

(22) Filed: May 25, 2022

(51) Int. Cl. B25B 27/00; B25B 27/02; B60G 7/00

(52) U.S. Cl. CPC B25B 27/0035; B25B 27/023; B60G 7/005; B60G 2206/92

(57) ABSTRACT

A removal tool for a ball joint contains: a first support arm, a second support arm, a first engagement post, a second engagement post, a first connector, and a second connector. The first support arm includes a rotatable fixing member and the first connector. The second support arm includes a rotatable screwing member and the second connector. The first support arm further includes a first fitting sleeve, and the second support arm includes a second fitting sleeve. The second engagement post includes a first threaded section, and the second engagement post includes a second threaded section, a spiral rotation direction of the first threaded section is opposite to a spiral rotation direction of the second threaded section.

### FIELD OF THE INVENTION

The present invention relates to a repair tool for a vehicle, and more particularly to a removal tool for a ball joint.

### BACKGROUND OF THE INVENTION

A conventional ball joint is connected with a suspension system and a steering system of a vehicle, and the conventional ball joint is replaced after being worn.

The present invention has arisen to mitigate and/or obviate the afore-described disadvantages.

### SUMMARY OF THE INVENTION

The primary objective of the present invention is to provide a removal tool for a ball joint which is applied to detach the ball joint from a suspension system or a steering system of a vehicle.

To obtain above-mentioned objective, a removal tool for a ball joint provided by the present invention contains: a first support arm, a second support arm, a first engagement post, a second engagement post, a first connector, and a second connector.

The first support arm corresponds to the second support arm, the first support arm includes a rotatable fixing member rotatably connected on a first end thereof, and the first support arm includes the first connector rotatably connected on a second end thereof. The second support arm includes a rotatable screwing member rotatably connected on a first end thereof, and the second support arm includes the second connector rotatably connected on a second end thereof, hence the first engagement post is screwed through the rotatable screwing member and is rotatably connected with the rotatable fixing member so that the first engagement post drives the rotatable screwing member to move close to or away from the rotatable fixing member.

The first support arm further includes a first fitting sleeve rotatably connected on a middle section thereof, and the second support arm includes a second fitting sleeve rotatably connected on a middle section thereof. The second engagement post includes a first threaded section formed on a first end thereof, and the second engagement post includes a second threaded section formed on a second end thereof. A spiral rotation direction of the first threaded section is opposite to a spiral rotation direction of the second threaded section, the first threaded section is screwed through the first fitting sleeve, and the second threaded section is screwed through the second fitting sleeve, such that the second engagement post drives the first fitting sleeve to move close to or away the second fitting sleeve, and the first connector is driven to move close to or away from the second connector, thus detaching the ball joint.

The first engagement post and the second engagement post are engaged with the first support arm and the second support arm so as to detach the ball joint easily.

### BRIEF DESCRIPTION OF THE DRAWINGS

FIG. 1 is a perspective view showing the assembly of a removal tool for a ball joint according to a preferred embodiment of the present invention.

FIG. 2 is a perspective view showing the exploded components of the removal tool for the ball joint according to the preferred embodiment of the present invention.

FIG. 3 is a side plan view showing the operation of the removal tool for the ball joint according to the preferred embodiment of the present invention.

FIG. 4 is another side plan view showing the operation of the removal tool for the ball joint according to the preferred embodiment of the present invention.

FIG. 5 is a perspective view showing the operation of the removal tool for the ball joint according to the preferred embodiment of the present invention.

FIG. 6 is another perspective view showing the operation of the removal tool for the ball joint according to the preferred embodiment of the present invention.

FIG. 7 is also another perspective view showing the operation of the removal tool for the ball joint according to the preferred embodiment of the present invention.

### DETAILED DESCRIPTION OF THE PREFERRED EMBODIMENTS

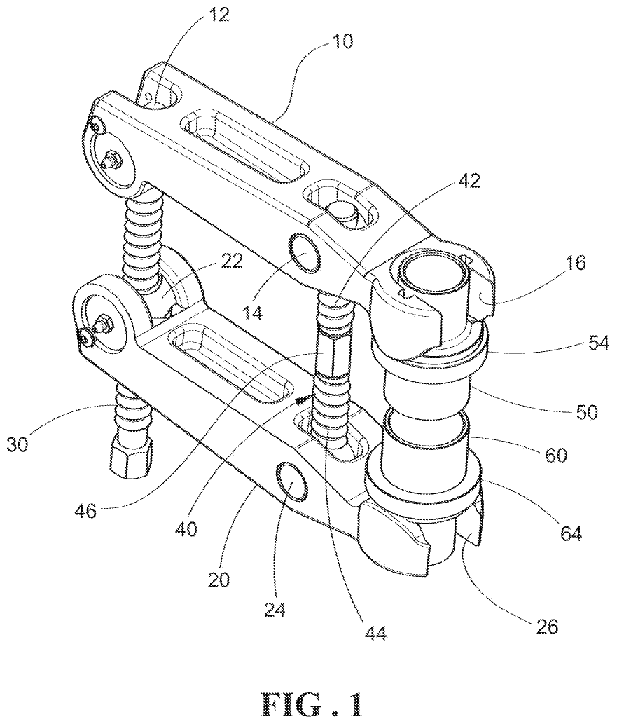

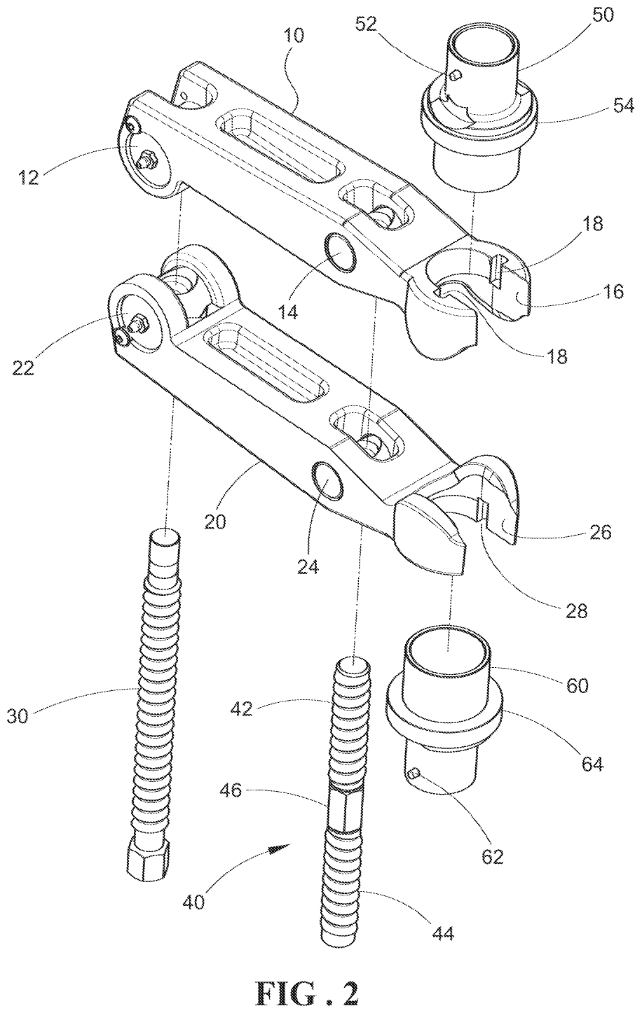

With reference to FIGS. 1 and 2, a removal tool for a ball joint according to a preferred embodiment of the present invention comprises: a first support arm 10, a second support arm 20, a first engagement post 30, a second engagement post 40, a first connector 50, and a second connector 60.

The first support arm 10 corresponds to the second support arm 20, and the first support arm 10 includes a rotatable fixing member 12 rotatably connected on a first end thereof, the first connector 50 rotatably connected on a second end of the first support arm 10; the second support arm 20 includes a rotatable screwing member 22 rotatably connected on a first end thereof, and the second connector 60 rotatably connected on a second end of the second support arm 20, hence the first connector 50 corresponds to the second connector 60, and the first engagement post 30 is screwed through the rotatable screwing member 22 and is rotatably connected with the rotatable fixing member 12 so that the first engagement post 30 drives the rotatable screwing member 22 to move close to or away from the rotatable fixing member 12.

The first support arm 10 further includes a first fitting sleeve 14 rotatably connected on a middle section thereof, and the second support arm 20 includes a second fitting sleeve 24 rotatably connected on a middle section thereof. The second engagement post includes a first threaded section 42 formed on a first end thereof, and the second engagement post 40 includes a second threaded section 44 formed on a second end thereof, wherein a spiral rotation direction of the first threaded section 42 is opposite to a spiral rotation direction of the second threaded section 44, the first threaded section 42 is screwed through the first fitting sleeve 14, the second threaded section 44 is screwed through the second fitting sleeve 24, such that the second engagement post 40 drives the first fitting sleeve 14 to move close to or away from the second fitting sleeve 24, and the first connector 50 is driven to move close to or away from the second connector 60, thus detaching the ball joint.

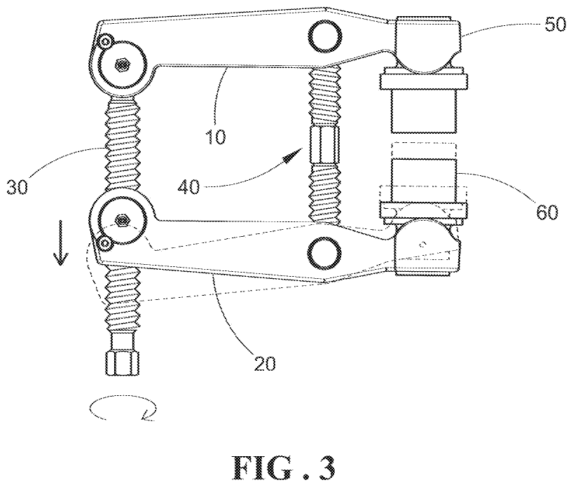

Referring to FIG. 3, when detaching the ball joint by moving the first connector 50 close to or away from the second connector 60, the first engagement post 30 is alternatively rotated so that the first engagement post 40 supports the first support arm and the second support arm 20, wherein when the rotatable screwing member 22 is moved close to the rotatable fixing member 12, the second connector 60 moves away from the second connector 50; when the rotatable screwing member 22 is moved away from the rotatable fixing member 12, the second connector 60 moves close to the first connector 50.

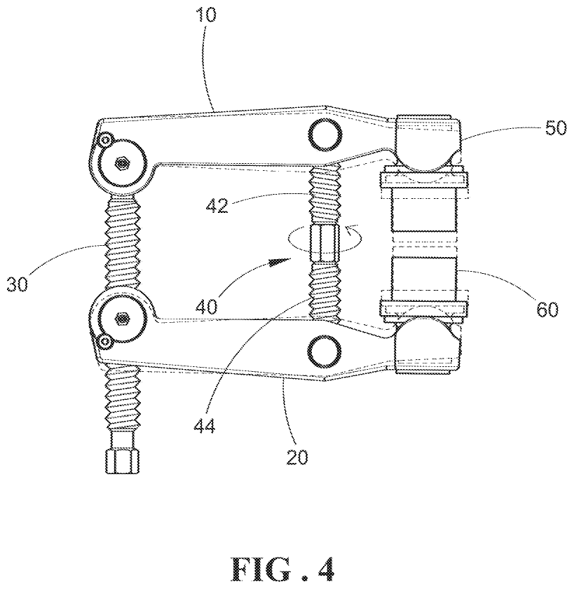

As shown in FIG. 4, when desiring to move the first connector 50 close to or away from the second connector 60, the second engagement post 40 is rotated alternatively so that the first engagement post 30 supports the first support arm 10 and the second support arm 20, wherein because the spiral rotation direction of the first threaded section 42 is opposite to the spiral rotation direction of the second threaded section 44, the first fitting sleeve 14 is moved close to or away from the second fitting sleeve 24 when rotating the first engagement post 3Q. For example, when the first fitting sleeve 14 is moved close to the second fitting sleeve 24, the first connector 50 moves close to the second connector 60. When the first fitting sleeve 14 is moved away from the second fitting sleeve 24, the first connector 50 moves away from the second connector 60.

Preferably, the first connector 50 is moved close to or away from the second connector 60 by rotating the first engagement post 30 and the second engagement post 40 alternatively.

The first support arm 10 and the second support arm 20 are engaged by the first engagement post 30 and the second engagement post 40 so that the ball joint is detachable easily.

The second engagement post 40 includes a polygonal operation portion 46 engaged by a wrench or other tools so as to drive the second engagement post 40 to rotate. The operation portion 46 is located between the first threaded section 42 and the second threaded section 44.

The first support arm 10 further includes a first accommodation groove 16 configured to accommodate the first connector 50, two first slidable slots 18 formed on two sides of the first accommodation groove 16, wherein a first end of a respective one first slidable slot 18 is closed, and a second end of the respective one first slidable slot 18 extends to the first support arm which is away from the second support arm 20. The first connector 50 includes two opposite first stems 52 extending from an outer wall thereof and rotatably received in the two first slidable slots 18, and a first circular tab 54 extending around the outer wall of the first connector 50 away from the two opposite first stems 52, wherein the first circular tab 54 contacts with the first support arm and faces the second support arm 20 so that the first connector 50 is rotatably connected on the first support arm 10.

The second support arm 20 further includes a second accommodation groove 26 configured to accommodate the second connector 60, two second slidable slots 28 formed on two sides of the second accommodation groove 26, wherein a first end of a respective one second slidable slot 28 is closed, and a second end of the respective one second slidable slot 28 extends to the second support arm 20 which is away from the first support arm 10. The second connector 60 includes two opposite second stems 62 extending from an outer wall thereof and rotatably received in the two second slidable slots 28, and a second circular tab 64 extending around the outer wall of the second connector 60 away from the two opposite second stems 62, wherein the second circular tab 64 contacts with the second support arm 20 and faces the first support arm 10 so that the second connector 60 is rotatably connected on the second support arm 20.

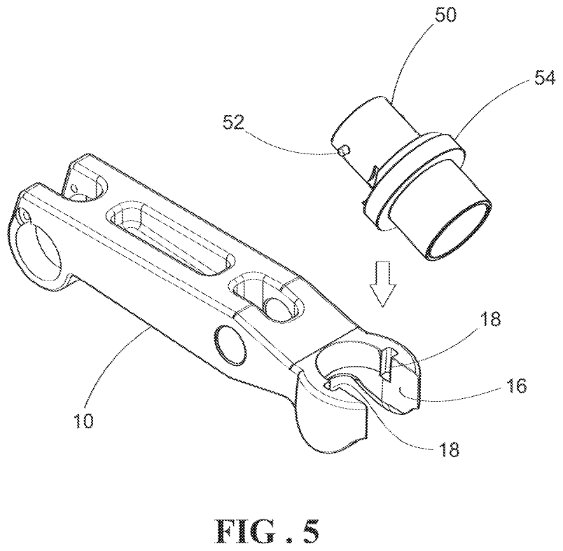

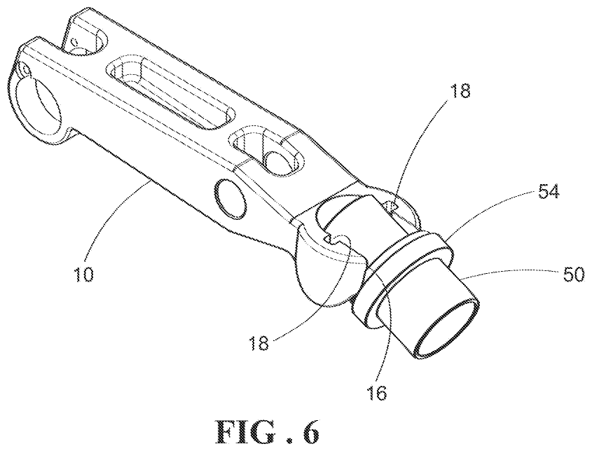

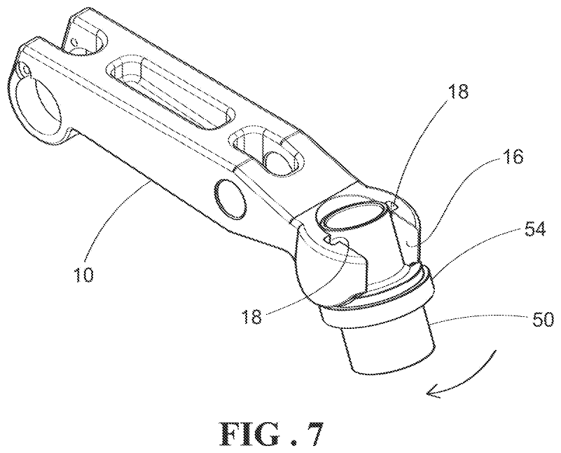

With reference to FIGS. 5-7, in operation, when desiring to connect the first connector 50 on the first support arm 10, the first connector 50 is rotatably accommodated in the first accommodation groove 16, and the two opposite first stems 52 are rotatably received in the two first slidable slots 18, such that the first connector 50 is rotated by way of the two opposite first stems 52, the first circular tab 54 is faced the second support arm 60 and is located between the first support arm 10 and the second support arm 20, wherein the first circular tab 54 contacts with the first support arm 10, thus connecting the first connector 50 on the first support arm 10.

A connection manner of the second connector 60 on the second support arm 20 is as connecting the first connector 50 on the first support arm 10.

The first end of the respective one first slidable slot 18 is closed so that a respective one first stem 52 is limited by the respective one first slidable slot 18, and an end of the outer wall of the first connector 50 away from the two opposite first stems 52 faces the second support arm 20, and the first support arm 10 limits the first circular tab 54, thus connecting the first connector 50 on the first support arm 10. The first end of the respective one second slidable slot 28 is closed so that a respective one second stem 62 is limited by the respective one second slidable slot 28, and an end of the outer wall of the second connector 60 away from the two opposite second stems 62 faces the first support arm 10, and the second support arm 20 limits the second circular tab 64, thus connecting the second connector 60 on the second support arm 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A removal tool for a ball joint comprising:
a first support arm, a second support arm, a first engagement post, a second engagement post, a first connector, and a second connector;
wherein the first support arm corresponds to the second support arm, the first support arm includes a rotatable fixing member rotatably connected on a first end thereof, and the first support arm includes the first connector rotatably connected on a second end thereof; the second support arm includes a rotatable screwing member rotatably connected on a first end thereof, and the second support arm includes the second connector rotatably connected on a second end thereof, hence the first engagement post is screwed through the rotatable screwing member and is rotatably connected with the rotatable fixing member so that the first engagement post drives the rotatable screwing member to move close to or away from the rotatable fixing member;
wherein the first support arm further includes a first fitting sleeve rotatably connected on a middle section thereof, and the second support arm includes a second fitting sleeve rotatably connected on a middle section thereof; the second engagement post includes a first threaded section formed on a first end thereof, and the second engagement post includes a second threaded section formed on a second end thereof, wherein a spiral rotation direction of the first threaded section is opposite to a spiral rotation direction of the second threaded section, the first threaded section is screwed through the first fitting sleeve, and the second threaded section is screwed through the second fitting sleeve, such that the second engagement post drives the first fitting sleeve to move close to or away the second fitting sleeve, and the first connector is driven to move close to or away from the second connector, thus detaching the ball joint.

2. The removal tool for the ball joint as claimed in claim 1, wherein the second engagement post includes a polygonal operation portion engaged by a wrench or other tools so as to drive the second engagement post to rotate.

3. The removal tool for the ball joint as claimed in claim 2, wherein the operation portion is located between the first threaded section and the second threaded section.

4. The removal tool for the ball joint as claimed in claim 1, wherein the first support arm further includes a first accommodation groove configured to accommodate the first connector, two first slidable slots formed on two sides of the first accommodation groove, wherein a first end of a respective one first slidable slot is closed, and a second end of the respective one first slidable slot extends to the first support arm which is away from the second support arm; the first connector includes two opposite first stems extending from an outer wall thereof and rotatably received in the two first slidable slots, and a first circular tab extending around the outer wall of the first connector away from the two opposite first stems, wherein the first circular tab contacts with the first support arm and faces the second support arm so that the first connector is rotatably connected on the first support arm;
wherein the second support arm further includes a second accommodation groove configured to accommodate the second connector, two second slidable slots formed on two sides of the second accommodation groove, wherein a first end of a respective one second slidable slot is closed, and a second end of the respective one second slidable slot extends to the second support arm which is away from the first support arm; the second connector includes two opposite second stems extending from an outer wall thereof and rotatably received in the two second slidable slots, and a second circular tab extending around the outer wall of the second connector away from the two opposite second stems, wherein the second circular tab contacts with the second support arm and faces the first support arm so that the second connector is rotatably connected on the second support arm.
